(19) United States
(12) Patent Application Publication
(10) Pub. No.: US 2014/0063435 A1
(43) Pub. Date: Mar. 6, 2014

(54) LIQUID CRYSTAL DISPLAY DEVICE

(71) Applicant: JAPAN DISPLAY INC., Tokyo (JP)

(72) Inventors: Mika OIWA, Tokyo (JP); Shinichi KOMURA, Tokyo (JP)

(73) Assignee: JAPAN DISPLAY INC., Tokyo (JP)

(21) Appl. No.: 14/018,607

(22) Filed: Sep. 5, 2013

(30) Foreign Application Priority Data
Sep. 5, 2012 (JP) 2012-195571

(51) Int. Cl. G02F 1/13

(52) U.S. Cl. CPC G02F 1/132
USPC 349/168; 349/188

(57) ABSTRACT

A liquid crystal display device includes a first substrate, a second substrate, a liquid crystal layer disposed between the first substrate and the second substrate, and an electrode group provided on at least one of the first substrate and the second substrate, and that applies an electric field to the liquid crystal layer, wherein the liquid crystal layer contains at least one liquid crystalline compound, and at least one chiral dopant, wherein one of the liquid crystalline compounds contained in the liquid crystal layer develops a blue phase liquid crystal, and wherein the liquid crystal layer has a storage elastic modulus G′ of 4,000 Pa or more at 25° C. and 1 Hz frequency.

### CROSS-REFERENCE TO RELATED APPLICATION

The present application claims priority from Japanese patent application JP2012-195571 filed on Sep. 5, 2012, the content of which is hereby incorporated by reference into this application.

### BACKGROUND OF THE INVENTION

1. Field of the Invention

The present invention relates to liquid crystal display devices.

2. Description of the Related Art

Blue phase liquid crystals are liquid crystal material used for liquid crystal panels, as disclosed in JP2010-250306A and other literatures. The blue phase liquid crystal can realize faster response compared to nematic liquid crystal, and by being optically isotropic, can dramatically improve contrast. There is also no viewing angle dependence because of the IPS driving. Further, because use of an alignment film can be omitted, the need for an alignment process such as rubbing, and an optical film used for viewing angle compensation can be eliminated when not using an alignment film, making it possible to produce a thin liquid crystal panel at low cost. There have been techniques intended to widen the very narrow temperature range of stable blue phases, raising expectations for actual applications.

### SUMMARY OF THE INVENTION

A problem of the blue phase liquid crystal offering high contrast and fast response and having potential in next-generation liquid crystal display applications is the narrow blue phase-developing temperature range of about several degrees (° C.). Liquid crystal display devices using a known polymer-stabilized blue phase liquid crystal for the liquid crystal layer have a wide blue phase-developing temperature range. However, the temperature range is still narrower than the practical temperature ranges usable for actual applications.

Actual applications of blue phase liquid crystal to liquid crystal display devices require a blue phase-developing temperature range covering a wide temperature range of from about −10° C. to 70° C. However, a blue phase liquid crystal covering such a wide temperature range is not known to date.

It is an object of the present invention to provide a liquid crystal display device that includes a liquid crystal layer having a wide blue phase-developing temperature range. This and other objects, and the novel features of the present invention will be made clear by the descriptions below and the accompanying drawings.

A liquid crystal display device according to the present invention includes a first substrate, a second substrate, a liquid crystal layer disposed between the first substrate and the second substrate, and an electrode group provided on at least one of the first substrate and the second substrate, and that applies an electric field to the liquid crystal layer, wherein the liquid crystal layer contains at least one liquid crystalline compound, and at least one chiral dopant, wherein one of the liquid crystalline compounds contained in the liquid crystal layer develops a blue phase liquid crystal, and wherein the liquid crystal layer has a storage elastic modulus G′ of 4,000 Pa or more at 25° C. and 1 Hz frequency.

One of the liquid crystalline compounds contained in the liquid crystal layer may have a TNI point (nematic-isotropic transition temperature) of 70° C. or more. The liquid crystal layer may contain a polymer polymerized from at least one polymerizable monomer. The liquid crystal layer may contain the polymer in 10.0 mol % or less. The polymer may be polymerized from at least two polymerizable monomers, and one of the polymerizable monomers may have a solubility parameter value greater than a solubility parameter value of the liquid crystalline compound, and the other polymerizable monomer may have a solubility parameter value less than the solubility parameter value of the liquid crystalline compound. The liquid crystal layer may contain a liquid crystalline compound that has a phenyl group, a cyano group, or a cyclic molecular structure within the molecular structure, and the chiral dopant maybe an isosorbide derivative, or a binaphthyl derivative.

A liquid crystal display device producing method according to the present invention is a method for producing a liquid crystal display device that includes a first substrate, a second substrate, a liquid crystal layer disposed between the first substrate and the second substrate, and an electrode group provided on at least one of the first substrate and the second substrate, and that applies an electric field to the liquid crystal layer, the liquid crystal layer containing at least one liquid crystalline compound and at least one chiral dopant, one of the liquid crystalline compounds contained in the liquid crystal layer developing a blue phase liquid crystal, the method including the liquid crystal layer viscosity adjusting step of adjusting the storage elastic modulus G′ of the liquid crystal layer to 4,000 Pa or more as measured at 25° C. and 1 Hz frequency.

The liquid crystal layer in the liquid crystal display device producing method may contain a polymer polymerized from at least one polymerizable monomer, and the liquid crystal layer viscosity adjusting step may adjust the 25° C. and 1 Hz frequency storage elastic modulus G′ of the liquid crystal layer to 4,000 Pa or more according to the degree of polymerization of the polymer.

With the present invention, a liquid crystal display device can be provided that includes a liquid crystal layer having a wide blue phase-developing temperature range.

### BRIEF DESCRIPTION OF THE DRAWINGS

FIG. 1A is a schematic block diagram schematically representing an exemplary structure of a liquid crystal display device according to present invention.

FIG. 1B is a schematic circuit diagram representing an exemplary circuit structure of one of the pixels of a liquid crystal display panel.

FIG. 1C is a schematic plan view schematically representing an exemplary structure of the liquid crystal display panel.

FIG. 1D is a schematic cross sectional view representing an example of the cross sectional configuration taken at line A-A of FIG. 1C.

FIG. 2A is a schematic plan view representing an example of the plane configuration of one of the pixels of the active matrix substrate in a liquid crystal display panel of an embodiment of the present invention.

FIG. 2B is a schematic plan view representing an example of the plane configuration with a counter substrate lying over the region shown in FIG. 2A.

FIG. 2C is a schematic cross sectional view representing an example of the cross sectional configuration taken at line B-B of FIGS. 2A and 2B.

FIG. 2D is a schematic cross sectional view representing an example of the cross sectional configuration taken at line C-C of FIGS. 2A and 2B.

FIG. 2E is a schematic cross sectional view representing an example of the cross sectional configuration taken at line D-D of FIGS. 2A and 2B.

FIG. 2F is a schematic cross sectional view representing an example of the cross sectional configuration taken at line E-E of FIGS. 2A and 2B.

FIG. 3 is a diagram depicting the viscoelasticity measurement device used for storage elastic modulus G′ measurement.

FIG. 4 represents the types and the concentrations of the polymerizable monomers used to form the polymer contained in the liquid crystal layer of the liquid crystal display device according to the present invention.

FIG. 5 is a diagram representing the storage elastic modulus Pa of a liquid crystal layer (25° C., 1 Hz frequency) containing the polymer formed by the polymerizable monomers of samples A to H.

FIG. 6 is a diagram representing the temperature ranges in which a blue phase occurs in the liquid crystal layers containing polymers formed by the polymerizable monomers of samples A to H.

FIG. 7A is a diagram representing the relationship between the storage elastic modulus of the liquid crystal layer at 25° C. and 1 Hz frequency, and the temperature range in which a blue phase occurs in the liquid crystal layer.

FIG. 7B is a diagram representing the relationship between the storage elastic modulus of the liquid crystal layer at 25° C. and 1 Hz frequency, and the lower limit temperature at which a blue phase occurs in the liquid crystal layer.

FIG. 8 is a diagram representing the result of the evaluation performed at −10° C. for the operation of liquid crystal display devices that include the polymers formed by the polymerizable monomers of samples A to H in the liquid crystal layer.

### DETAILED DESCRIPTION OF THE INVENTION

An embodiment of the present invention is described below in detail with reference to the accompanying drawings. The present invention may be appropriately altered, provided that such changes do not depart from the technical ideas disclosed in the embodiment and examples below.

In the all appended figures referred to in the descriptions below, functionally similar components and features are appended with the same reference numerals, and explanations thereof will not be repeated.

The liquid crystal display device according to the present embodiment is, for example, an active-matrix-type liquid crystal display device having a plurality of switching elements, and includes a pair of substrates at least one of which is transparent; a liquid crystal layer LC disposed between the pair of substrates; an electrode structure formed on one of the pair of substrates, and that generates in the liquid crystal layer an electric field having a component dominantly parallel to the substrate surface; a pair of alignment control films formed on the pair of substrates in surfaces in contact with the liquid crystal layer; and a pair of polarizing plates disposed to sandwich the pair of substrates.

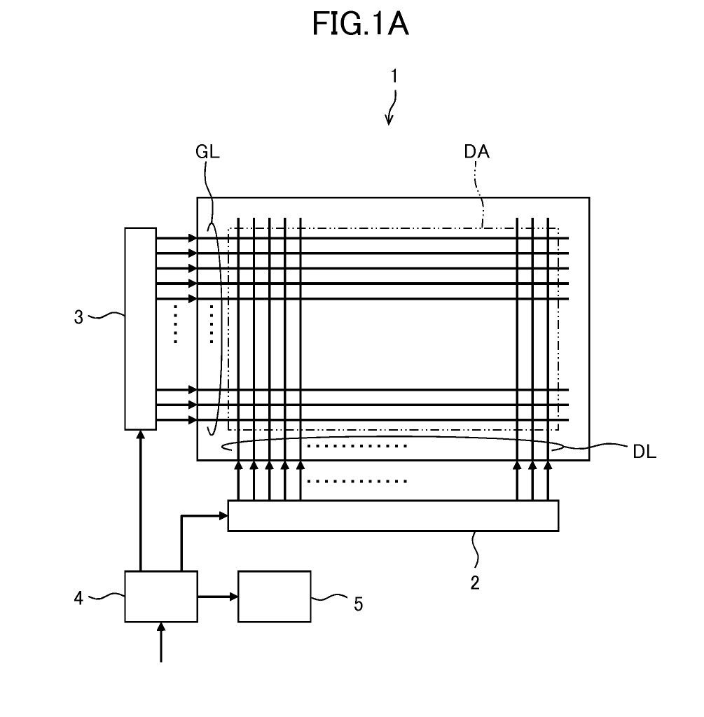

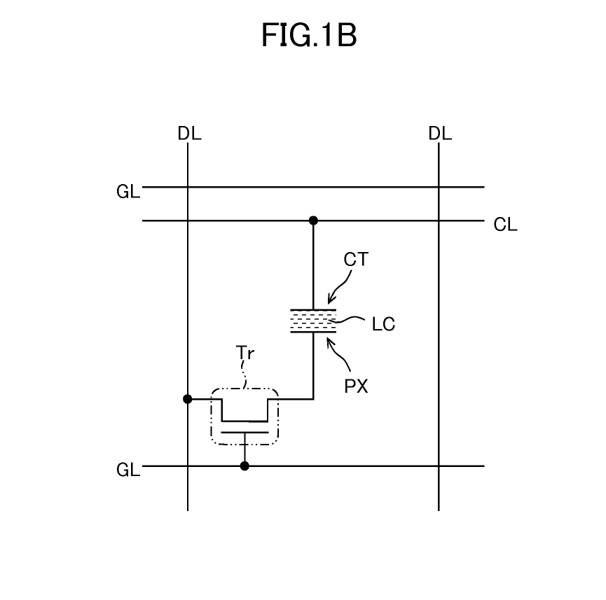

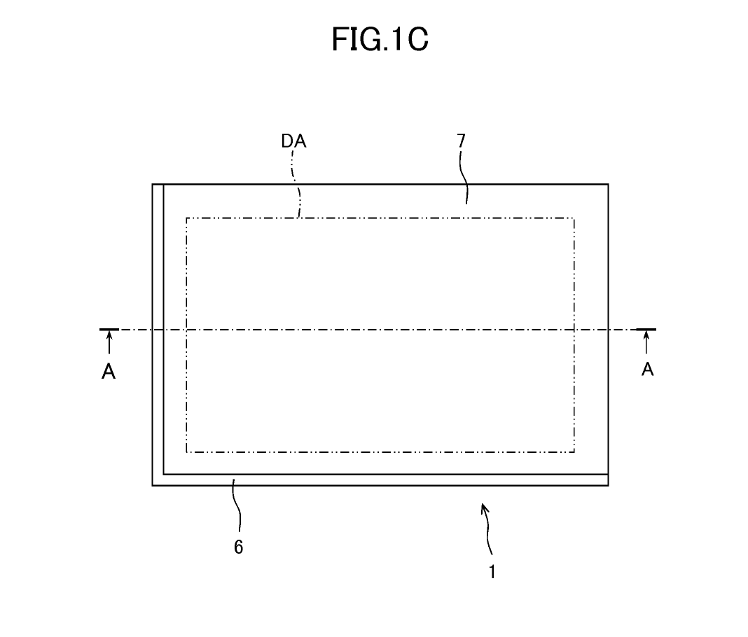

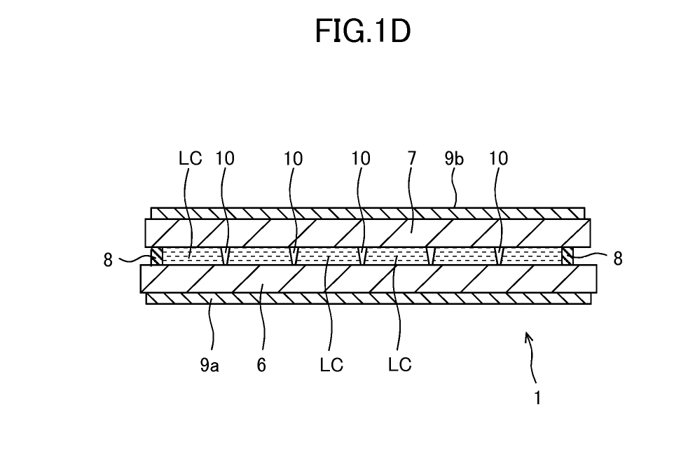

FIGS. 1A to 1D are schematic diagrams schematically representing the structure of the liquid crystal display device according to the embodiment of the present invention.

FIG. 1A is a schematic block diagram schematically representing the structure of the liquid crystal display device according to present embodiment. FIG. 1B is a schematic circuit diagram representing the circuit structure of one of the pixels of the liquid crystal display panel according to the present embodiment. FIG. 1C is a schematic plan view schematically representing the structure of the liquid crystal display panel according to the present embodiment. FIG. 1D is a schematic cross sectional view representing a cross sectional configuration taken at line A-A of FIG. 1C.

The active-matrix-type liquid crystal display device includes, for example, a liquid crystal display panel 1, a first drive circuit 2, a second drive circuit 3, a control circuit 4, and a backlight 5, as illustrated in FIG. 1A.

The liquid crystal display panel 1 includes a plurality of scan signal lines GL (gate lines), and a plurality of video signal lines DL (drain lines). The video signal lines DL are connected to the first drive circuit 2. The scan signal lines GL are connected to the second drive circuit 3. The liquid crystal display panel 1 has a display area DA configured as a collection of large numbers of pixels. Each pixel has a circuit structure configured as shown in, for example, FIG. 1B, and includes a TFT element Tr (active element), a pixel electrode PX, a common electrode CT (also referred to as “counter electrode”), and a liquid crystal layer LC (liquid crystal material). The liquid crystal display panel 1 also includes, for example, common lines CL shared by the common electrodes CT of the plurality of pixels.

The liquid crystal display panel 1 has a structure in which the liquid crystal layer LC is disposed between the active matrix substrate 6 and the counter substrate 7, as illustrated in FIGS. 1C and 1D, for example. The active matrix substrate 6 and the counter substrate 7 are bonded to each other with an annular sealant 8 provided on the outer side of the display area DA, and the liquid crystal layer LC is sealed in the space surrounded by the active matrix substrate 6, the counter substrate 7, and the sealant 8. The liquid crystal display panel 1 of the liquid crystal display device having the backlight 5 also has a pair of polarizing plates 9a and 9b provided opposite from each other with the active matrix substrate 6, the liquid crystal layer LC, and the counter substrate 7 in between.

Further, in the liquid crystal display device according to the present embodiment, a plurality of columnar spacers 10 may be provided in the sealed space of the liquid crystal layer LC to, for example, provide a uniform thickness (also referred to as “cell gap”) for the liquid crystal layer LC in each pixel.

The present invention is concerned with the material composition of the liquid crystal layer LC of the liquid crystal display panel 1 in the active-matrix-type liquid crystal display device. Accordingly, no detailed description will be made with regard to the configurations of the first drive circuit 2, the second drive circuit 3, the control circuit 4, and the backlight 5 not directly relevant to the present invention.

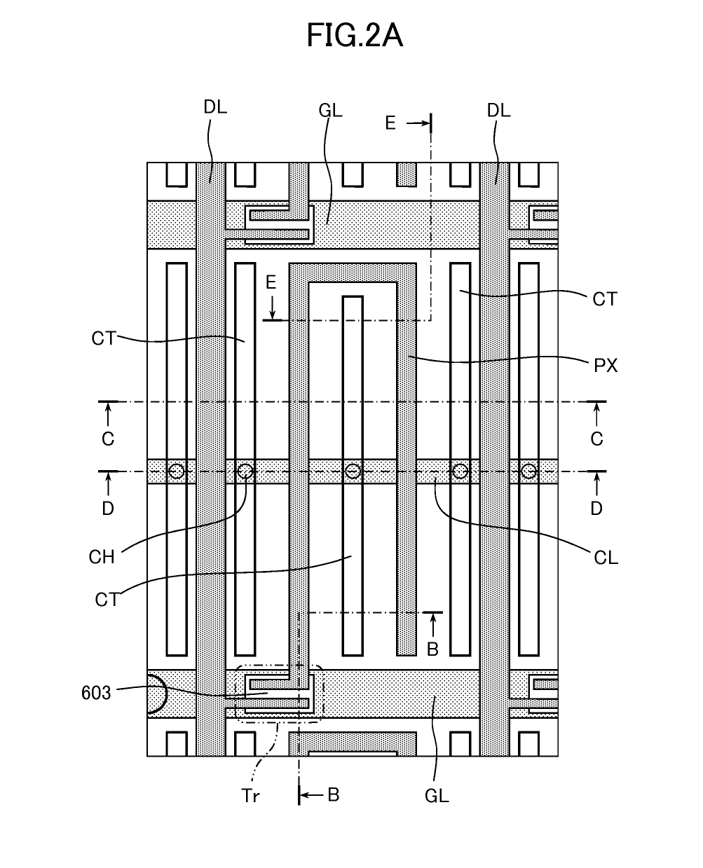

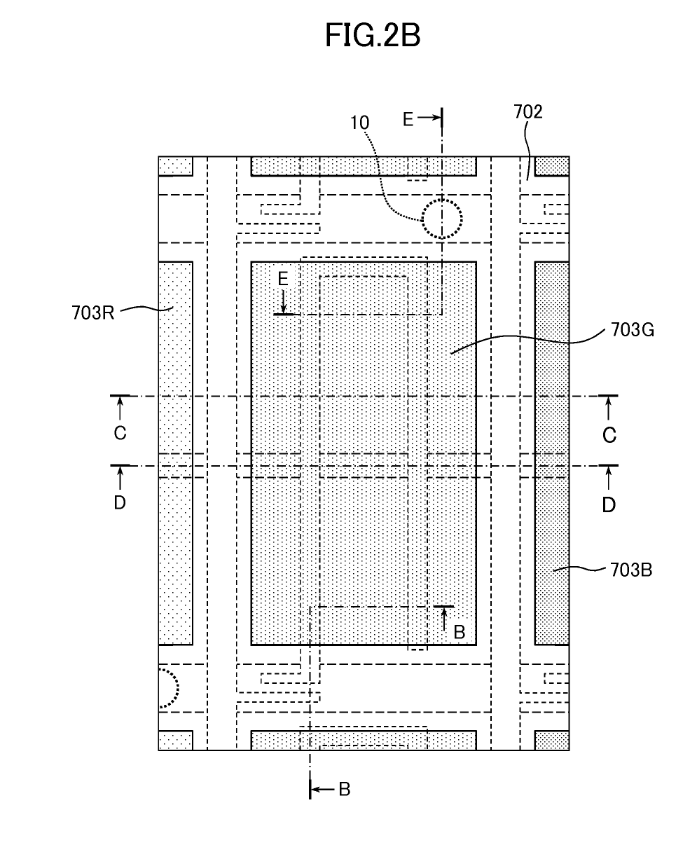

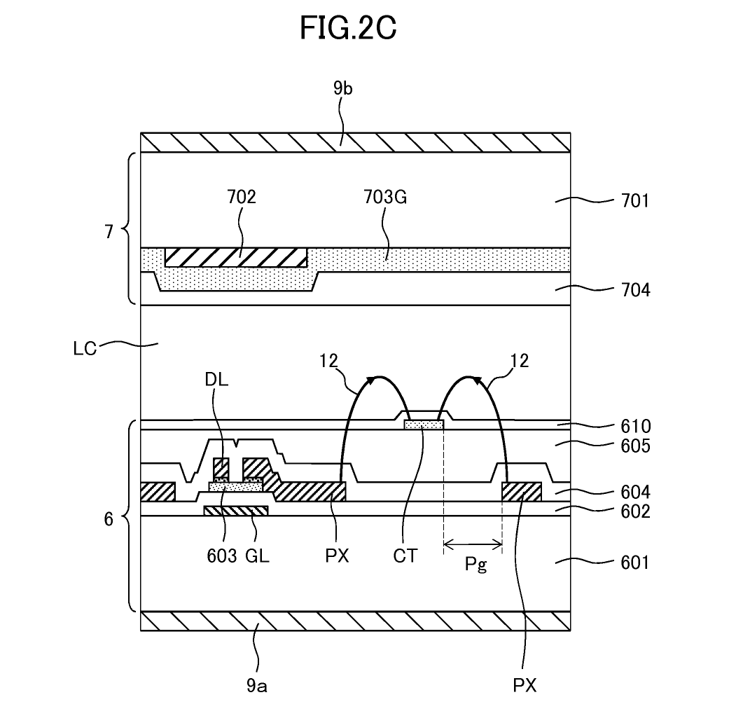

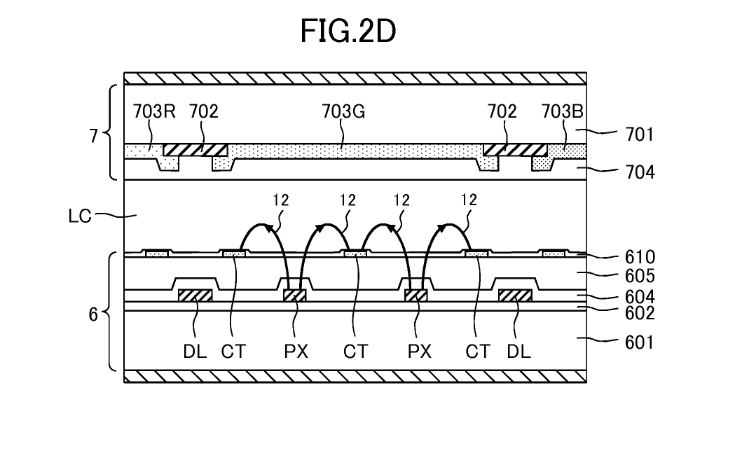

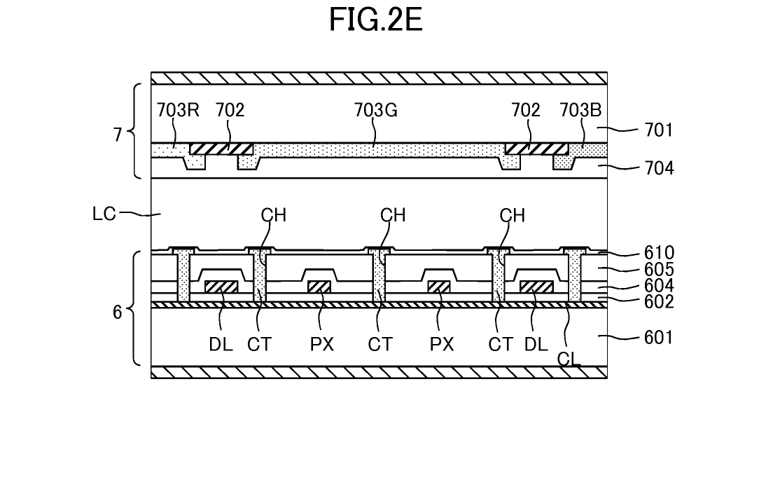

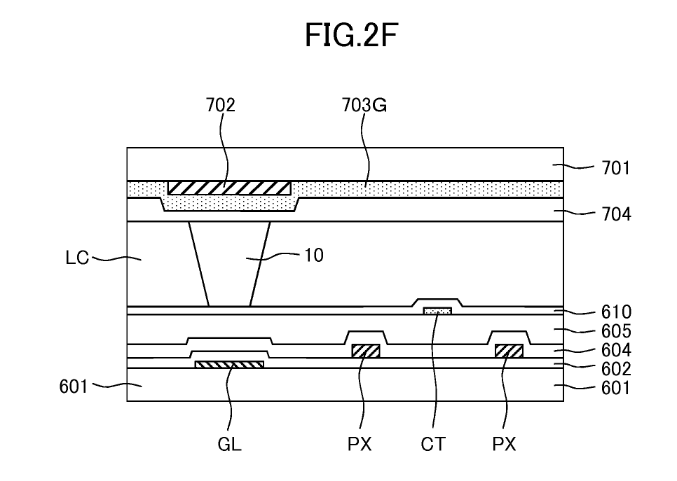

FIGS. 2A to 2F are schematic diagrams schematically representing an exemplary structure of the IPS liquid crystal display panel according to an embodiment of the present invention.

FIG. 2A is a schematic plan view representing an example of the plane configuration of one of the pixels of the active matrix substrate in the liquid crystal display panel of the embodiment. FIG. 2B is a schematic plan view representing an example of the plane configuration with the counter substrate lying over the region shown in FIG. 2A. FIG. 2C is a schematic cross sectional view representing an example of the cross sectional configuration taken at line B-B of FIGS. 2A and 2B. FIG. 2D is a schematic cross sectional view representing an example of the cross sectional configuration taken at line C-C of FIGS. 2A and 2B. FIG. 2E is a schematic cross sectional view representing an example of the cross sectional configuration taken at line D-D of FIGS. 2A and 2B. FIG. 2F is a schematic cross sectional view representing an example of the cross sectional configuration taken at line E-E of FIGS. 2A and 2B.

Note that the lines B-B, C-C, D-D, and E-E in FIG. 2A are lines projected on the active matrix substrate 6 over the lines B-B, C-C, D-D, and E-E of FIG. 2B, respectively. FIG. 2F shows only the cross sectional configuration of the liquid crystal layer LC, and the active matrix substrate 6 and the counter substrate 7 in the vicinity of the liquid crystal layer LC.

In an embodiment of the present invention, an IPS liquid crystal display panel driven by in-plane electric field represents an example of the liquid crystal display panel 1 to which the present invention is applicable. In this case, each pixel and the surrounding area in the liquid crystal display panel 1 has the configuration shown in, for example, FIGS. 2A through 2F.

The active matrix substrate 6 includes the scan signal lines GL and the common lines CL formed on the surface of an insulating substrate such as a glass substrate 601, and a first insulating layer 602 covering these components.

A semiconductor layer 603 of the TFT element Tr, the video signal lines DL and the pixel electrode PX, and a second insulating layer 604 covering these components are formed on the first insulating layer 602. The semiconductor layer 603 is disposed on the scan signal line GL, and the portion of the scan signal lines GL beneath the semiconductor layer 603 serves as the gate electrode of the TFT element Tr. The semiconductor layer 603 is configured, for example, as a laminate of an active layer (channel forming layer) of first amorphous silicon, and a source diffusion layer and a drain diffusion layer of second amorphous silicon that differs from the first amorphous silicon in the type of impurities, and concentration. Here, the video signal line DL and the pixel electrode PX partially lie over the semiconductor layer 603, and these overlying portions on the semiconductor layer 603 serve as the drain electrode and the source electrode of the TFT element Tr.

The source and drain of the TFT element Tr are switched according to the bias, specifically the potential levels of the pixel electrode PX and the video signal line DL at turn-on of the TFT element Tr. However, in the descriptions below, the electrodes connected to the video signal line DL and the pixel electrode will be referred to as drain electrode and source electrode, respectively.

A third insulating layer 605 (overcoat layer) having a planarized surface is formed on the second insulating layer 604.

On the third insulating layer 605 are formed the common electrode CT, and a transparent layer 610 covering the common electrode CT and the third insulating layer 605. The common electrode CT is connected to the common lines CL through contact holes CH (through hole) formed through the first insulating layer 602, the second insulating layer 604, and the third insulating layer 605. For example, the common electrode CT is formed in a manner that provides a gap Pg (see FIG. 2C) of about 7 μm from the pixel electrode PX in the plane shown in FIG. 2A.

On the other hand, the counter substrate 7 includes a black matrix 702, color filters 703R, 703G, and 703B, and an overcoat layer 704 covering these components. These are formed on the surface of an insulating substrate such as a glass substrate 701. For example, the black matrix 702 is a grid-like light shielding film that provides aperture regions in units of pixels in the display area DA. The color filters 703R, 703G, and 703B are, for example, films that allow passage of only the light of specific wavelengths (colors) from the white light from the backlight 5, and are adapted to transmit red, green, and blue light, respectively, when the liquid crystal display device accommodates an RGB color display. The surface of the overcoat layer 704 is planarized.

The plurality of columnar spacers 10, and an alignment film 705 are formed on the overcoat layer 704. The columnar spacers 10 are, for example, circular truncated cones (also referred to as “solid of revolution of a trapezoid”) with a flat top, and are formed in positions that overlie the scan signal lines GL of the active matrix substrate 6, except for portions where the TFT elements Tr are disposed, and portions crossing the video signal lines DL.

A potential difference created between the pixel electrode PX and the common electrode CT upon applying a gradation voltage to the pixel electrode PX from the video signal lines DL in response to turn-on of the TFT element Tr generates an electric field 12 (line of electric force) as shown in FIGS. 2B and 2C. The electric field 12 is applied to the liquid crystal layer LC in an intensity that varies according to the potential difference between the pixel electrode PX and the common electrode CT. Here, the interaction between the dielectric anisotropy of the liquid crystal layer LC and the electric field 12 varies the refractive anisotropy of the liquid crystal layer LC. The magnitude of the refractive index anisotropy is determined by the applied intensity of the electric field 12 (the magnitude of the potential difference between the pixel electrode PX and the common electrode CT). The liquid crystal display device can thus produce a video or image display by, for example, varying the optical transmittance in each pixel under the pixel-wise control of the gradation voltage applied to the pixel electrode PX with the fixed common electrode CT potential.

The liquid crystal layer LC is described below. The liquid crystal layer LC of the present embodiment includes at least one liquid crystalline compound, and at least one chiral dopant. A blue phase liquid crystal occurs from one of the liquid crystalline compounds contained in the liquid crystal layer LC. The liquid crystal layer LC has a storage elastic modulus G′ (dynamic shear storage elastic modulus) of 4,000 Pa or more at 25° C. and 1 Hz frequency.

The liquid crystalline compound that develops a blue phase is, for example, one with which a blue phase can occur between the cholesteric phase (chiral nematic phase) and the isotropic phase. The liquid crystalline compound that develops a blue phase may be a thermotropic liquid crystal.

Further, the liquid crystalline compound that develops a blue phase may be, for example, a liquid crystalline compound that has a biphenyl, terphenyl, or biphenyl-cyclohexyl molecular structure, and that itself has chirality with an asymmetric atom.

Further, the liquid crystalline compound that develops a blue phase may be a liquid crystalline compound that can develop a cholesteric phase (chiral nematic phase) with the chiral dopant (chiral substance) contained in the liquid crystal layer. Nematic liquid crystals represent an example of such liquid crystalline compounds. More specifically, for example, the liquid crystalline compound contained in the liquid crystal layer LC in the present embodiment may be nematic liquid crystal JC1041XX (Chisso), 4-pentyl-4′-cyanobiphenyl (5CB; Aldrich), or a predetermined molar ratio mixture of these.

One of the liquid crystalline compounds contained in the liquid crystal layer LC of the present embodiment may have a TNI point (nematic-isotropic phase transition temperature) of 70° C. or more. Specifically, the blue phase liquid crystal-developing liquid crystalline compound contained in the liquid crystal layer LC of the present embodiment may be a liquid crystalline compound having a TNI point of 70° C. or more. Further, the liquid crystal layer LC may contain a liquid crystalline compound having a TNI point of 70° C. or more, different from the blue phase liquid crystal-developing liquid crystalline compound contained in the liquid crystal layer LC of the present embodiment, in addition to the blue phase liquid crystal-developing liquid crystalline compound. The TNI point of the liquid crystalline compounds as a whole contained in the liquid crystal layer LC is measured by visually checking the phase-change temperature of a liquid crystalline compound mixture prepared with the molar ratio of these compounds as they occur in the liquid crystal layer LC. Further, for example, the extent of coloring in the liquid crystalline compound mixture may present difficulties in the visual measurement of phase-change temperature. In this case, the TNI point of the liquid crystalline compounds as a whole may be a phase-change temperature of the mixture as measured by the DSC (differential scanning calorimetry) of a liquid crystalline compound mixture prepared with the molar ratio of these compounds as they occur in the liquid crystal layer LC. Further, the liquid crystalline compounds contained in the liquid crystal layer LC of the present embodiment as a whole may have a TNI point (nematic-isotropic phase transition temperature) of 70° C. or more.

In order to have a TNI point (nematic-isotropic phase transition temperature) of 70° C. or more, one of the liquid crystalline compounds contained in the liquid crystal layer LC may be a liquid crystalline compound that has a phenyl group, a cyano group, or cyclic or other molecular structures within the molecular structure. More specifically, one of the liquid crystalline compounds contained in the liquid crystal layer LC may be a trifluoro cyclic compound. With the liquid crystalline compound having a TNI point of 70° C. or more, the liquid crystal layer LC can greatly widen the operating temperature range of the liquid crystal display device 1 of the present embodiment. Further, with the liquid crystalline compound having a TNI point of 70° C. or more, the liquid crystal display device 1 of the present embodiment can be used at high temperatures (for example, 70° C. or more).

When the liquid crystal layer LC does not contain a liquid crystalline compound having a TNI point of 70° C. or more, the upper limit of the operating temperature range of the liquid crystal display device will also remain below 70° C. (at most 40° C.), and accordingly the liquid crystal display device will have a narrow operating temperature range. In the present embodiment, the melting temperature (Tc value) of the liquid crystal layer of the liquid crystal display device 1 may be 70° C. or more.

For example, in the case of a liquid crystal display device that includes a liquid crystal layer LC containing about 47 mol % of nematic liquid crystal JC1041XX (Chisso) and about 47 mol % of 4-pentyl-4′-cyanobiphenyl (5CB; Aldrich) as liquid crystalline compounds, and about 6 mol % of chiral dopant ZLI-4572, the upper limit of the operating temperature range of the liquid crystal display device is below 70° C. (Tc value) and remains at most 40° C., and the product liquid crystal display device will have narrow operating temperatures.

The upper limit of the TNI point of the liquid crystalline compounds contained in the liquid crystal layer LC is not particularly limited, and may be, for example, 120° C. or less. Tc value also may be, for example, 120° C. or less, as with the case of the TNI point.

The liquid crystal layer LC of the present embodiment may further contain a liquid crystalline compound having a dielectric constant anisotropy Δε of 10 or more, in addition to the liquid crystalline compounds described above. The liquid crystalline compounds contained in the liquid crystal layer LC of the present embodiment, as a whole, may have Δε of 10 or more.

Specifically, the blue phase liquid crystal-developing liquid crystalline compound contained in the liquid crystal layer LC of the present embodiment may be a liquid crystalline compound having Δε of 10 or more. Further, the liquid crystal layer LC may contain a liquid crystalline compound having Δε of 10 or more, different from the blue phase liquid crystal-developing liquid crystalline compound contained in the liquid crystal layer LC of the present embodiment, in addition to the blue phase liquid crystal-developing liquid crystalline compound. Here, the Δε of the liquid crystalline compounds is a value measured from volume changes of the liquid crystalline compound.

The liquid crystalline compound having Δε of 10 or more may be, for example, a cyanodifluoroester.

With the liquid crystalline compound having Δε of 10 or more, or with the liquid crystalline compounds having Δε of 10 or more as a whole, the liquid crystal layer LC can greatly lower the drive voltage of the liquid crystal display device 1 of the present embodiment (for example, 70 V or less).

The chiral dopant is contained in the liquid crystal layer LC of the present embodiment to provide a twist structure in the liquid crystal. Further, the molecular structure of the chiral dopant contained in the liquid crystal layer LC may have axial chirality and a structure similar to the liquid crystal. The chiral dopant used in the present embodiment may be, for example, a chiral compound of a ring structure having an optically active site, for example, such as binaphthyl derivatives, abietic acid derivatives, and isosorbide derivatives. Further, the chiral dopant in the present embodiment may be, for example, a binaphthyl derivative. More specifically, the chiral dopant in the present embodiment may be an isosorbide derivative, or a binaphthyl derivative represented by the following formula (1).

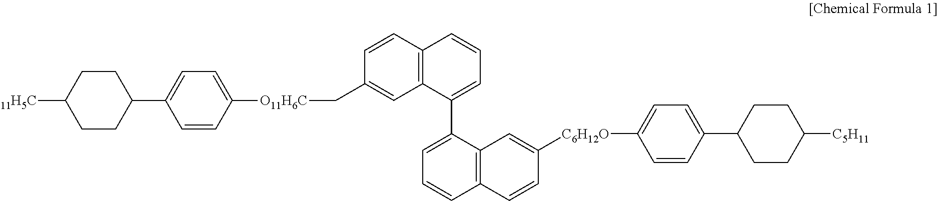

The wavelength of the Bragg diffraction light in a blue phase may be controlled by the concentration of the binaphthyl derivative added as the chiral dopant to the liquid crystal layer LC. In this case, the concentration of the binaphthyl derivative in the liquid crystal layer LC may be determined according to the disclosure in JP2011-90278A.

The liquid crystal layer LC of the present embodiment has a storage elastic modulus G′ of 4,000 Pa or more at 25° C. and 1 Hz frequency. The liquid crystal layer LC of the present embodiment may have a storage elastic modulus G′ of 4,500 Pa or more at 25° C. and 1 Hz frequency.

The upper limit of the storage elastic modulus G′ of the liquid crystal layer LC of the present embodiment at 25° C. and 1 Hz frequency is not particularly limited, and may be, for example, 40,000 Pa or less.

When the storage elastic modulus G′ of the liquid crystal layer LC at 25° C. and 1 Hz frequency is 4,000 Pa or more, the liquid crystal layer LC can widen the blue phase-developing temperature range, and can provide a liquid crystal display device of a wide operating temperature range. Further, with the liquid crystal layer LC having a storage elastic modulus G′ of 4,000 Pa or more at 25° C. and 1 Hz frequency, the liquid crystal display device 1 can desirably be used at low temperatures (−10° C. or less).

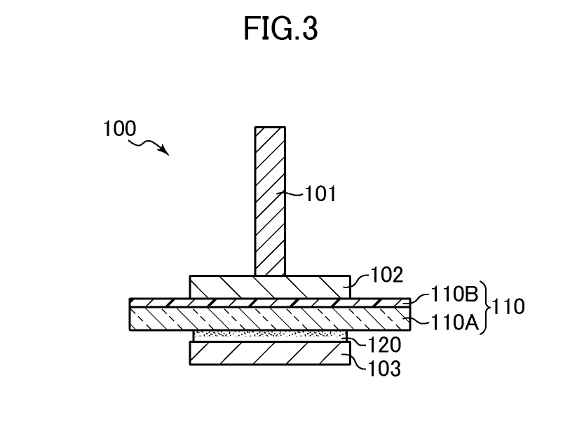

Storage elastic modulus G′ can be measured by using a known method, using the viscoelasticity measurement device shown in FIG. 3. A method for measuring storage elastic modulus G′ is described below with reference to FIG. 3. FIG. 3 is a diagram depicting the viscoelasticity measurement device used for storage elastic modulus G′ measurement. As illustrated in FIG. 2, the viscoelasticity measurement device includes a rotating shaft 101, an upper disc 102 fixably connected to the rotating shaft 101, and a lower disc 103 disposed opposite from the upper disc 102. An adhesive layer 120 is provided on the surface of the lower disc 103 facing the upper disc 102. A test object 110 is mounted between the upper disc 102 and the lower disc 103 by being fixed via the adhesive layer 120. The test object 110 is a laminate of a PSBP (polymer stabilized blue phase) film 110B forming a blue phase to be measured, and a substrate 110A fixing the PSBP film.

Storage elastic modulus G′ measurement in the present invention was performed with Rheo Stress RS100 (HAAKE). Measurement was made at a position where a stable storage elastic modulus G′ could be obtained, specifically a position about 0.002 mm into the liquid crystal layer (PSBP film 110B) under the pressure of the upper disc 102 pressed in the thickness direction of the liquid crystal layer. Measurement is made at a temperature of 25° C. and 1 Hz frequency (revolution) under 3 Pa pressure.

The storage elastic modulus G′ of the liquid crystal layer LC at 25° C. and 1 Hz frequency greatly varies according to the combination and the mixture ratio of the compounds forming the liquid crystal layer LC. In order to have a storage elastic modulus G′ of 4,000 Pa or more at 25° C. and 1 Hz frequency, the liquid crystal layer LC may contain a polymer polymerized from one or more polymerizable monomers, or carbon nanotubes or carbon nanohorns.

Further, in order to have a storage elastic modulus G′ of 4,000 Pa or more at 25° C. and 1 Hz frequency, the liquid crystal layer LC of the present embodiment may contain a polymer polymerized from one or more polymerizable monomers.

When the liquid crystal layer LC contains a polymer, the polymerizable monomer forming the polymer preferably has a large number of reactive functional groups for polymerization. Specifically, when the liquid crystal layer LC contains a polymer, the polymerizable monomer forming the polymer is more preferably multifunctional, rather than being monofunctional. Further, when the polymer is polymerized from two or more polymerizable monomers, each polymerizable monomer may have a plurality of reactive functional groups for polymerization. That is, the polymer contained in the liquid crystal layer LC may be formed from two or more multifunctional polymerizable monomers.

When the liquid crystal layer LC contains a polymer, the polymerizable monomer forming the polymer preferably has a ring structure. Specifically, when the liquid crystal layer LC contains a polymer, the polymerizable monomer forming the polymer may have one or more ring structures selected from a benzene ring and a cyclohexane ring within the structure. That is, when the liquid crystal layer LC contains a polymer, the polymerizable monomer forming the polymer may have one or more ring structures selected from a benzene ring and a cyclohexane ring within the structure.

The polymer contained in the liquid crystal layer LC may be polymerized from two or more polymerizable monomers, and one of the polymerizable monomers may have a solubility parameter value greater than the solubility parameter value of the liquid crystalline compound contained in the liquid crystal layer LC, whereas the solubility parameter value of the other polymerizable monomer may be smaller than the solubility parameter value of the liquid crystalline compound contained in the liquid crystal layer LC.

By controlling the solubility parameter value of the liquid crystalline compound contained in the liquid crystal layer LC, and the solubility parameter value of each polymerizable monomer forming the polymer, the polymer becomes more likely to enter the disclination of the liquid crystal structure formed by the liquid crystalline compound. This contributes to stabilizing the liquid crystal layer LC, and further enhances the advantages of the present invention.

The liquid crystal layer LC of the present embodiment may contain the foregoing polymer in 15.0 mol % or less. A polymer content in the liquid crystal layer LC above 15.0 mol % is not preferable, because it increases the drive voltage of the liquid crystal display device, and has the risk of not developing the blue phase itself. Further, the liquid crystal layer LC of the present embodiment preferably contains the foregoing polymer in 10.0 mol % or less. The advantages of the present invention can be further enhanced with the polymer content of 10.0 mol % or less in the liquid crystal layer LC. The lower limit of the polymer content in the liquid crystal layer LC is not particularly limited, and, for example, the liquid crystal layer LC of the present embodiment may contain the foregoing polymer in 1.0 mol % or more, or 5.0 mol % or more.

The following describes an exemplary method for producing the liquid crystal display panel 1. In the descriptions below, no detailed explanations will be made for steps that can be performed by using the procedures of conventional liquid crystal display panel producing methods.

Broadly, the method for producing the liquid crystal display panel 1 of the present embodiment includes three steps: the step of forming the active matrix substrate 6, the step of forming the counter substrate 7, and the step of bonding the active matrix substrate 6 and the counter substrate 7 to each other to seal the liquid crystal material (liquid crystal layer LC).

The step of forming the active matrix substrate 6 is performed with, for example, the glass substrate 601 having a thickness of 0.7 mm after surface polishing. First, the scan signal lines GL and the common lines CL are formed on the surface of the glass substrate 601. The scan signal lines GL and the common line CL are formed, for example, by etching a metal film such as a chromium film (Cr film) formed over the whole surface of the glass substrate 601.

This is followed by formation of the first insulating layer 602. The first insulating layer 602 is formed, for example, by depositing a silicon nitride film of about 0.3 μm thick over the whole surface of the glass substrate 601.

Then, an island-shaped semiconductor film for the semiconductor layer 603 of the TFT element Tr is formed. The island-shaped semiconductor film is formed, for example, by etching an amorphous silicon film formed over the whole surface of the first insulating layer 602. The amorphous silicon film is formed, for example, as a laminate of a first amorphous silicon layer, and a second amorphous silicon layer that differs from the first amorphous silicon layer in conductivity type, or in the type or concentration of impurities. When forming the island-shaped semiconductor film, other layers, for example, such as a shorting preventing layer interposed at the intersecting regions of the scan signal lines GL and the video signal lines DL is simultaneously formed.

This is followed by formation of the video signal lines DL and the pixel electrodes PX. The video signal lines DL and the pixel electrodes PX are formed, for example, by etching a metal film such as a chromium film formed on the first insulating layer 602. Here, the video signal lines DL are formed in a manner allowing it to have a portion that lies over the island-shaped semiconductor film, specifically a portion that serves as the drain electrode of the TFT element Tr. Similarly, the pixel electrodes PX are formed in a manner allowing it to have a portion that lies over the island-shaped semiconductor film, specifically a portion that serves as the source electrode of the TFT element.

Then, the second amorphous silicon layer of the island-shaped semiconductor film is etched and separated into the drain diffusion layer and the source diffusion layer, using the video signal lines DL and the pixel electrodes PX as masks. The semiconductor layer 603 of the TFT element Tr is obtained as a result.

This is followed by formation of the second insulating layer 604 and the third insulating layer 605. The second insulating layer 604 is formed, for example, by depositing a silicon nitride film having a thickness of about 0.3 μm. The third insulating layer is formed, for example, by applying an uncured acrylic resin, and heating and curing the resin under predetermined conditions, for example, at a temperature of 220° C. for 1 hour. The third insulating layer 605 may be formed, for example, by using heat-curable resins, such as epoxyacrylic resin and polyimide resin that excel in insulation and transparency. It is also possible to form the third insulating layer 605, for example, by using a light-curable transparent resin, or an inorganic material such as polysiloxane.

Then, the contact hole CH is formed in a predetermined region of the common line CL, penetrating through the first insulating layer 602, the second insulating layer 604, and the third insulating layer 605. The contact hole CH is formed by etching the first insulating layer 602, the second insulating layer 604, and the third insulating layer 605.

Then, the common electrodes CT are formed. The common electrodes CT are formed, for example, by etching a transparent conductive film such as an ITO film formed on the third insulating layer 605 in a thickness of about 50 nm.

The step of forming the counter substrate 7 of the liquid crystal display panel 1 can be performed by using conventional procedures, and is not described.

The step of bonding the active matrix substrate 6 and the counter substrate 7 to each other, and sealing various materials of the liquid crystal layer LC between the active matrix substrate 6 and the counter substrate 7 is performed, for example, by applying the annular sealant 8 to the periphery of the display area DA of the counter substrate 7, and bonding the active matrix substrate after dropping the liquid crystal material in the region surrounded by the sealant 8.

As described above, the liquid crystal layer LC provided in the liquid crystal display device 1 according to the present embodiment contains at least one liquid crystalline compound, and at least one chiral dopant, and one of the liquid crystalline compounds contained in the liquid crystal layer LC develops a blue phase liquid crystal. The method for producing the liquid crystal display device 1 according to the present embodiment includes the liquid crystal layer viscosity adjusting step of adjusting the storage elastic modulus G′ of the liquid crystal layer LC to 4,000 Pa or more as measured at 25° C. and 1 Hz frequency.

The storage elastic modulus G′ of the liquid crystal layer LC maybe adjusted, for example, by mixing a polymer in the liquid crystal layer LC, as described above.

For example, when the polymer is formed by polymerizing polymerizable monomer, it is preferable to photo-polymerize the polymerizable monomer under ultraviolet light. To describe more specifically, it is preferable to seal at least one liquid crystalline compound, at least one chiral dopant, and a polymerizable monomer that polymerizes with at least one kind of ultraviolet light between the active matrix substrate 6 and the counter substrate 7, and polymerize the polymerizable monomer by irradiation of ultraviolet light in a temperature range in which the liquid crystalline compound exhibits a blue phase to form the polymer.

When forming the polymer by polymerizing polymerizable monomer, it is not preferable to polymerize the polymerizable monomer by heating. This is because heating the polymerizable monomer makes it difficult for the liquid crystalline compound contained in the liquid crystal layer LC to remain in the temperature range in which a blue phase occurs.

When adding polymer to the liquid crystal layer LC, it is preferable to obtain the predetermined storage elastic modulus G′ with as small a mixed amount of the polymer as possible, because, depending on the mixed polymer amount, the drive voltage of the liquid crystal display device may increase, and suppress the occurrence of a blue phase in the liquid crystal layer LC.

Specifically, when the polymer is formed from photopolymerizable monomer, and when the photopolymerized polymer is contained in the liquid crystal layer LC in 10.0 mol % or less, it is preferable to adjust the predetermined storage elastic modulus by controlling the intensity of ultraviolet irradiation.

For example, when two polymerizable monomers EHA/RM257 (=70/30 mol %) are contained in the liquid crystal layer LC in 10.0 mol % or less, a radiation intensity of 1.9 mWcm⁻² (UV: 365 nm) or more is needed to obtain the predetermined storage elastic modulus. Desirably, the polymer is formed by polymerization at a radiation intensity of preferably 2.0 mWcm⁻² (UV: 365 nm) or more.

This is because, depending on the type of the photopolymerizable monomer, the storage elastic modulus G′ can be greatly improved by increasing the degree of polymerization, and polymerization using a high radiation intensity than in ordinary polymerization reactions ensures the predetermined storage elastic modulus G′, and thus widens the operating temperature range of the liquid crystal display device 1.

The present embodiment has been described through the case where the liquid crystal display panel 1 is an in-plane switching liquid crystal display panel with the pixel configuration represented in FIGS. 2A through 2F. However, the pixel configuration, for example, the plane shape (plane layout) of the TFT element Tr, the pixel electrode PX, and the common electrode CT is not limited to the foregoing example, and may be appropriately altered.

Further, the TFT element Tr shown in FIGS. 2A and 2C is of a bottom-gate structure in which the semiconductor layer 603 is disposed on the scan signal lines GL. However, the structure is not limited to this, and the TFT element Tr may have a top-gate structure in which the semiconductor layer 603 is disposed between the glass substrate 601 and the scan signal lines GL. Further, a film such as an alignment film may be formed on the active matrix substrate 6 and the counter substrate 7 on the side of the liquid crystal layer LC. A blue phase liquid crystal can be made without an alignment film as in the present embodiment. However, as with the case of using the existing nematic phase, an alignment film of a polyimide resin obtained by heating polyamic acid may be formed by performing a rubbing process that provides a liquid crystal aligning surface.

The foregoing described the schematic structure of the IPS liquid crystal panel as an embodiment of the present invention with reference to FIGS. 1 to 2F. However, the electrode structure is not limited to this, as long as it allows light to make passage to the front of the panel surface. The method of production, and other configurations are also not limited to the ones described above.

### EXAMPLES

The following more specifically describes the liquid crystal display device that includes a first substrate, a second substrate, a liquid crystal layer disposed between the first substrate and the second substrate, and an electrode group provided on at least one of the first substrate and the second substrate, and that applies an electric field to the liquid crystal layer, wherein the liquid crystal layer contains at least one liquid crystalline compound, and at least one chiral dopant, wherein one of the liquid crystalline compounds contained in the liquid crystal layer develops a blue phase liquid crystal, and wherein the liquid crystal layer has a storage elastic modulus G′ of 4,000 Pa or more at 25° C. and 1 Hz frequency.

The liquid crystal display devices used in Examples had the IPS liquid crystal display device structure, and an equimolar mixture of nematic liquid crystal JC1041XX (Chisso) and 4-pentyl-4′-cyanobiphenyl (5CB; Aldrich) was used as the liquid crystalline compound contained in the liquid crystal layer. The liquid crystal layer contained the chiral dopant of the chemical formula (1) above in a proportion of 5.0 mol %, and a liquid crystalline compound having a high TNI point (a TNI point of 70° C. or more) was added after being prepared to have a Tc value of 70° C.

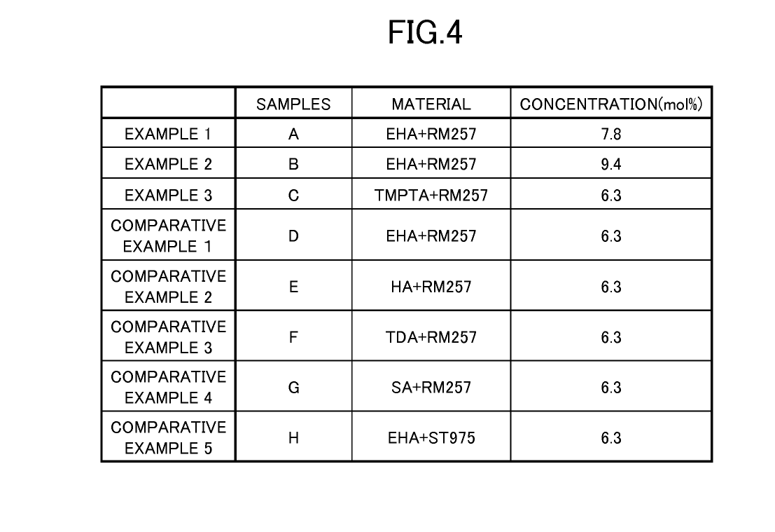

Photopolymerizable monomers were used to form the polymer for adjusting the storage elastic modulus G′ of the liquid crystal layer to the predetermined value as measured at 25° C. and 1 Hz frequency. FIG. 4 represents the types and the concentrations of the polymerizable monomers used to form the polymer contained in the liquid crystal layer of the liquid crystal display device according to the present invention. As shown in FIG. 4, two materials (polymerizable monomers) were used as a 60:40 (molar ratio) mixture to form the polymer. Specifically, in the case of sample A of Example 1, an EHA:RM257=60:40 (molar ratio) mixture was used as the polymer-forming polymerizable monomer. Each concentration presented in FIG. 4 represents the total proportion of the polymerizable monomers mixed in the liquid crystal layer, specifically the mixture concentration of the polymer in the liquid crystal layer.

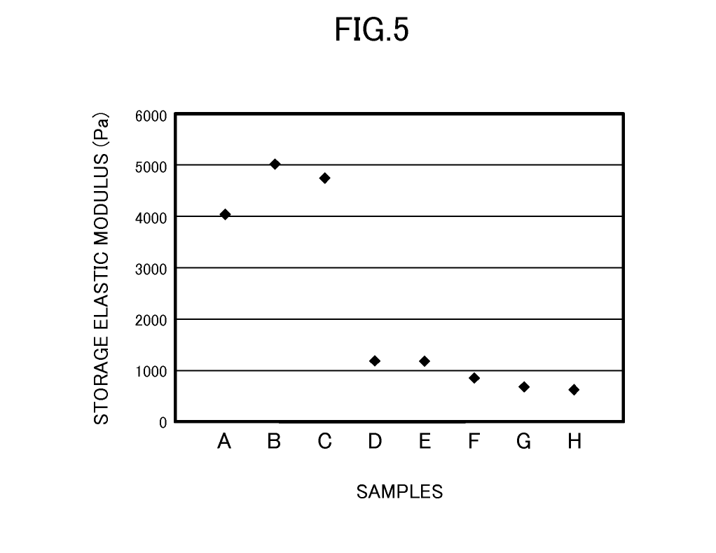

FIG. 5 is a diagram representing the storage elastic modulus Pa of the liquid crystal layer (25° C., 1 Hz frequency) containing the polymer formed by the polymerizable monomers of samples A to H. As represented in FIG. 5, the polymer was formed under adjusted polymerization conditions (ultraviolet radiation intensity) so as to make the storage elastic modulus of the liquid crystal layer 4,000 Pa or more at 25° C. and 1 Hz frequency with the polymer formed by the polymerizable monomers of samples A to C.

On the other hand, the polymer was formed under adjusted polymerization conditions (ultraviolet radiation intensity) so as to make the storage elastic modulus of the liquid crystal layer below 4,000 Pa at 25° C. and 1 Hz frequency with the polymer formed by the polymerizable monomers of samples D to H.

In Examples, the measurement of the storage elastic modulus of the liquid crystal layer at 25° C. and 1 Hz frequency was performed with Rheo Stress RS100 (HAAKE), as noted above.

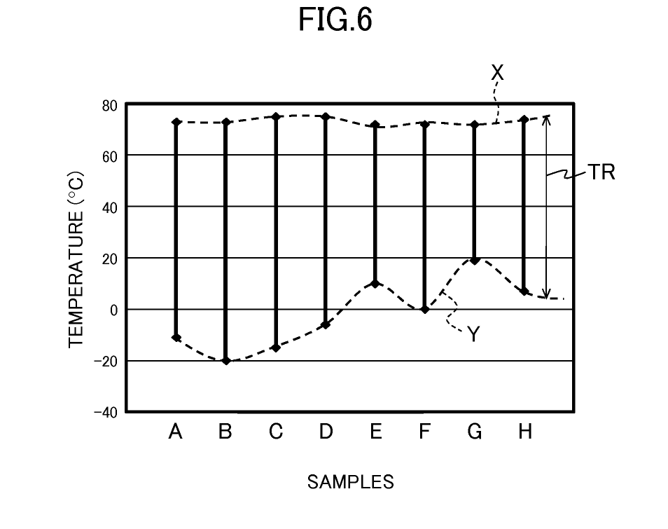

FIG. 6 is a diagram representing the temperature ranges in which a blue phase occurs in the liquid crystal layers containing the polymers formed by the polymerizable monomers of samples A to H. The upper limit X of the temperature range TR in which a blue phase occurs in the liquid crystal layer is the temperature at which the liquid crystal starts to melt. The lower limit Y of the blue phase-developing temperature range TR of the liquid crystal layer is the temperature at which the liquid crystal shows anisotropy with the polarizing plates under a crossed nicols condition.

As represented in FIG. 6, the temperature range TR in which a blue phase occurs in the liquid crystal layers containing the polymers formed by the polymerizable monomers is wider with samples A to C than with samples D to H. As can be seen, the temperature range TR in which a blue phase occurs in the liquid crystal layers containing the polymers formed by the polymerizable monomers of samples A to C is particularly wider toward lower temperatures.

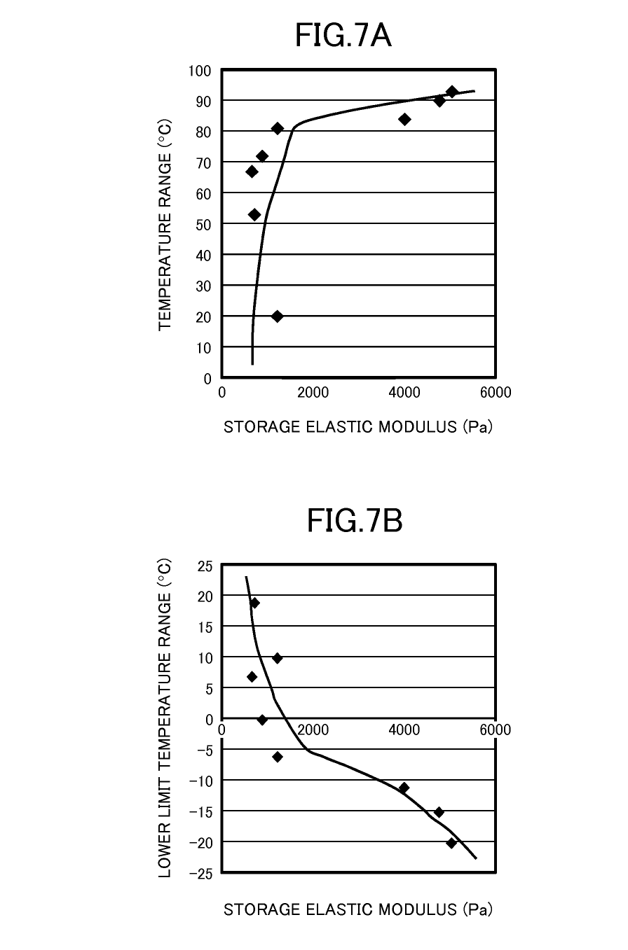

FIG. 7A is a diagram representing the relationship between the storage elastic modulus of the liquid crystal layer at 25° C. and 1 Hz frequency, and the temperature range in which a blue phase occurs in the liquid crystal layer. FIG. 7B is a diagram representing the relationship between the storage elastic modulus of the liquid crystal layer at 25° C. and 1 Hz frequency, and the lower limit temperature at which a blue phase occurs in the liquid crystal layer.

As can be seen in FIG. 7A, the temperature range in which a blue phase occurs in the liquid crystal layer is 80° C. or more when the storage elastic modulus of the liquid crystal layer is 4,000 Pa or more at 25° C. and 1 Hz frequency. Further, the temperature range in which a blue phase occurs in the liquid crystal layer is 80° C. or more when the storage elastic modulus of the liquid crystal layer is 4,000 Pa or more at 25° C. and 1 Hz frequency.

As can be seen in FIG. 7B, the lower limit temperature at which a blue phase occurs in the liquid crystal layer is −10° C. or less when the storage elastic modulus of the liquid crystal layer is 4,000 Pa or more at 25° C. and 1 Hz frequency.

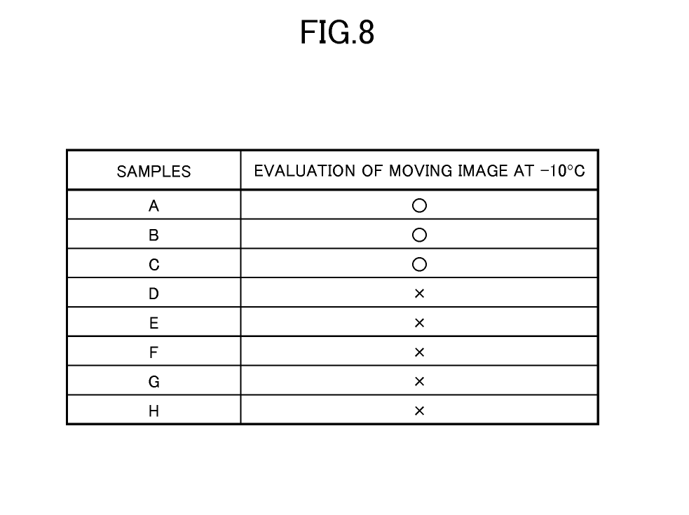

FIG. 8 is a diagram representing the result of the evaluation performed at −10° C. for the operation of the liquid crystal display devices that included the polymers formed by the polymerizable monomers of samples A to H in the liquid crystal layer. In FIG. 8, open circle indicates that the liquid crystal display device operated without any problem in the −10° C. operation evaluation, and cross indicates that the liquid crystal display device failed to operate at −10° C. in the operation evaluation. While there have been described what are at present considered to be certain embodiments of the invention, it will be understood that various modifications may be made thereto, and it is intended that the appended claims cover all such modifications as fall within the true spirit and scope of the invention.

What is claimed is:

1. A liquid crystal display device, comprising:
a first substrate;
a second substrate;
a liquid crystal layer disposed between the first substrate and the second substrate; and
an electrode group provided on at least one of the first substrate and the second substrate, and that applies an electric field to the liquid crystal layer,
wherein the liquid crystal layer contains at least one liquid crystalline compound, and at least one chiral dopant,
wherein one of the liquid crystalline compounds contained in the liquid crystal layer develops a blue phase liquid crystal, and
wherein the liquid crystal layer has a storage elastic modulus G′ of 4,000 Pa or more at 25° C. and 1 Hz frequency.

2. The liquid crystal display device according to claim 1, wherein one of the liquid crystalline compounds contained in the liquid crystal layer has a TNI point (nematic-isotropic transition temperature) of 70° C. or more.

3. The liquid crystal display device according to claim 1, wherein the liquid crystal layer contains a polymer polymerized from at least one polymerizable monomer.

4. The liquid crystal display device according to claim 3, wherein the liquid crystal layer contains the polymer in 10.0 mol % or less.

5. The liquid crystal display device according to claim 3, wherein the polymer is polymerized from at least two polymerizable monomers,
one of the polymerizable monomers having a solubility parameter value greater than a solubility parameter value of the liquid crystalline compound,
the other polymerizable monomer having a solubility parameter value less than the solubility parameter value of the liquid crystalline compound.

6. The liquid crystal display device according to claim 1,
wherein the liquid crystal layer contains a liquid crystalline compound that has a phenyl group, a cyano group, or a cyclic molecular structure within the molecular structure, and
wherein the chiral dopant is an isosorbide derivative, or a binaphthyl derivative.

7. A method for producing a liquid crystal display device that includes a first substrate, a second substrate, a liquid crystal layer disposed between the first substrate and the second substrate, and an electrode group provided on at least one of the first substrate and the second substrate, and that applies an electric field to the liquid crystal layer,
the liquid crystal layer containing at least one liquid crystalline compound, and at least one chiral dopant,
one of the liquid crystalline compounds contained in the liquid crystal layer developing a blue phase liquid crystal,
the method comprising the liquid crystal layer viscosity adjusting step of adjusting the storage elastic modulus G′ of the liquid crystal layer to 4,000 Pa or more as measured at 25° C. and 1 Hz frequency.

8. The method according to claim 7,
wherein the liquid crystal layer contains a polymer polymerized from at least one polymerizable monomer, and
wherein the liquid crystal layer viscosity adjusting step adjusts the 25° C. and 1 Hz frequency storage elastic modulus G′ of the liquid crystal layer to 4,000 Pa or more according to the degree of polymerization of the polymer.
